(19) United States
(12) Patent Application Publication
(10) Pub. No.: US 2015/0160397 A1
(43) Pub. Date: Jun. 11, 2015

(54) DISPLAY DEVICE AND MANUFACTURING METHOD THEREOF

(71) Applicant: Tian Zhang, Shenzhen (CN)

(72) Inventor: Tian Zhang, Shenzhen (CN)

(21) Appl. No.: 14/241,420

(22) PCT Filed: Jan. 22, 2014
(86) PCT No.: PCT/CN2014/071097

§ 371 Date: Jun. 3, 2014

(30) Foreign Application Priority Data
Jul. 19, 2013 (CN) 201310305765.1

(51) Int. Cl. F21V 8/00

(52) U.S. Cl. CPC G02B 6/0031; G02B 6/0025; G02B 6/0023; G02B 6/0065

(57) ABSTRACT

The present invention relates to the field of panel display technology, and provides a display device and a manufacturing method thereof. The display device includes a light guide plate; a light-emitting element located on one side of the light guide plate; and a light mixing unit located between the light guide plate and the light-emitting element which unit includes a sealed transparent container and a light mixing substance filled in the container, wherein the light mixing unit enables light from the light-emitting element to be subjected to one or more of scattering, refraction and diffusion. The device and method according to the invention can reduce the light mixing distance of the light-emitting element so as to provide a display with a narrow frame area.

### FIELD OF THE INVENTION

The present disclosure relates to a display device and a manufacturing method thereof, and particularly, relates to a display device including a light mixing unit and a manufacturing method thereof.

### BACKGROUND OF THE INVENTION

A display having a narrow frame area is a direction for development of current display devices. Besides the geometric size of each component, the most important one of the factors restricting a display having a narrow frame area is the light mixing distance, namely the distance it takes for point light sources of light-emitting diodes to be mixed into a homogenized surface light source.

In order to shorten the light mixing distance, in the prior art it is generally attempted to reduce the distance between the light-emitting diodes, provide microstructures on a light guide plate which affects the propagation path of light, or provide an optical lens to cover the surface of the light-emitting diodes for changing the propagation path of light.

However, in the prior art, the light mixing distance always exist no matter what measures are taken to shorten it. In addition, the frame would be further widened due to the geometric sizes of the optical lens and the microstructure.

### SUMMARY OF THE INVENTION

In order to avoid the above-mentioned defects in the prior art, the present disclosure proposes a display device and a corresponding manufacturing method, which can reduce the width of a frame by shortening the light mixing distance, so as to provide a display having a narrow frame area.

In a first embodiment, the display device according to the present disclosure includes a light guide plate; a light-emitting element located on one side of the light guide plate; and a light mixing unit located between the light guide plate and the light-emitting element, and including a sealed transparent container and a light mixing substance filled in the container, wherein the light mixing unit is configured to enable light from the light-emitting element to be subjected to one or more of scattering, refraction and diffusion.

In a second embodiment improved according to the first embodiment, wherein the container and the light guide plate are integrated into one single body.

In a third embodiment improved according to the first embodiment, wherein the container is bonded with the light guide plate with optical adhesive.

In a fourth embodiment improved according to the first embodiment, wherein the container and the light-emitting element are integrated into one single body, so that the light mixing substance surrounds the side of the light-emitting element facing the light guide plate.

In a fifth embodiment improved according to the first embodiment, wherein the device further includes a support between the light-emitting element and the light guide plate, which support is provided with at least two side walls extending from the light-emitting element to the light guide plate, with the light mixing unit arranged between the side walls of the support.

In a sixth embodiment improved according to the fifth embodiment, wherein a reflecting sheet is arranged on the inner surface of the side wall of the support. The reflecting sheets are configured to keep the light inside the interior of the support.

In a seventh embodiment improved according to any of the above-mentioned embodiments, wherein the light mixing unit further includes a reflecting film arranged on the outer surface of the container at the end in a first direction, which is vertical to the direction of the container facing the light-emitting element and the light guide plate. The reflecting film is configured to improve the utilization rate of light.

In an eighth embodiment improved according to any of the above-mentioned embodiments, wherein the light mixing substance includes one or more of liquid crystals, atomized acetone and atomized water vapor.

In a ninth embodiment improved according to the seventh embodiment, wherein the reflecting film is arranged on the container through attaching or plating.

The present disclosure also proposes a method for manufacturing the above-mentioned display device, including: step (a), providing a container, and filling a light mixing substance into the container; step (b), sealing the container; and step (c), disposing the sealed container between a light guide plate and a light-emitting element of the display device.

According to the device and the method of the present disclosure, with the light mixing unit as provided, refraction, scattering, diffusion and the like can be greatly increased on the light from the light-emitting element, and the propagation path of the light is changed accordingly, which greatly shortens the light mixing distance of the light-emitting element. As a result, the light from point light sources can be converted into homogenized light within a relatively short distance. Thus, during the process of manufacturing the display device, the width of the frame can be reduced, and a display having a narrow frame area which cannot be realized in the prior art can be achieved.

Meanwhile, the display device according to the present disclosure is provided with the reflecting film on the side of the light mixing unit, thus improving the utilization rate of the light.

The above-mentioned technical features may be combined in various appropriate manners or substituted by equivalent technical features, as long as the objective of the present disclosure can be fulfilled.

### BRIEF DESCRIPTION OF THE DRAWINGS

The present disclosure will be described in more detail below based on merely nonfinite examples with reference to the accompanying drawings. Wherein:

FIG. 1 schematically shows structure of a display device according to the present disclosure;

FIG. 2 schematically shows principle of the display device according to the present disclosure;

FIG. 3 schematically shows a first example of the display device according to the present disclosure

FIG. 4 schematically shows a second example of the display device according to the present disclosure; and

FIG. 5 schematically shows a third example of the display device according to the present disclosure.

In the drawings, the same components are indicated by the same reference signs. The accompanying drawings are not drawn in an actual scale.

### DETAILED DESCRIPTION OF THE EMBODIMENTS

The present disclosure will be introduced in detail below with reference to the accompanying drawings.

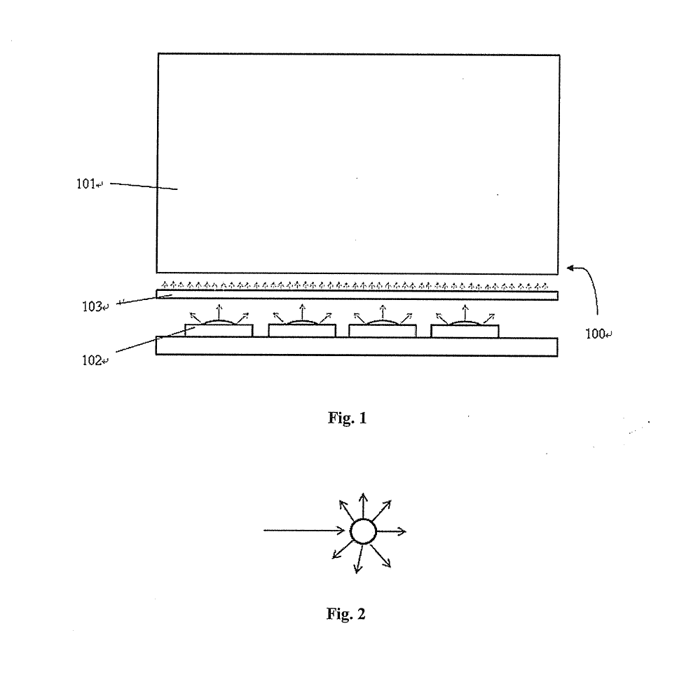

FIG. 1 schematically shows a main structure of a display device 100 according to the present disclosure. The display device 100 includes a light guide plate 101 for guiding the propagation path of light, a light-emitting element 102 located on one side of the light guide plate 101, and a light mixing unit 103 located between the light guide plate 101 and the light-emitting element 102.

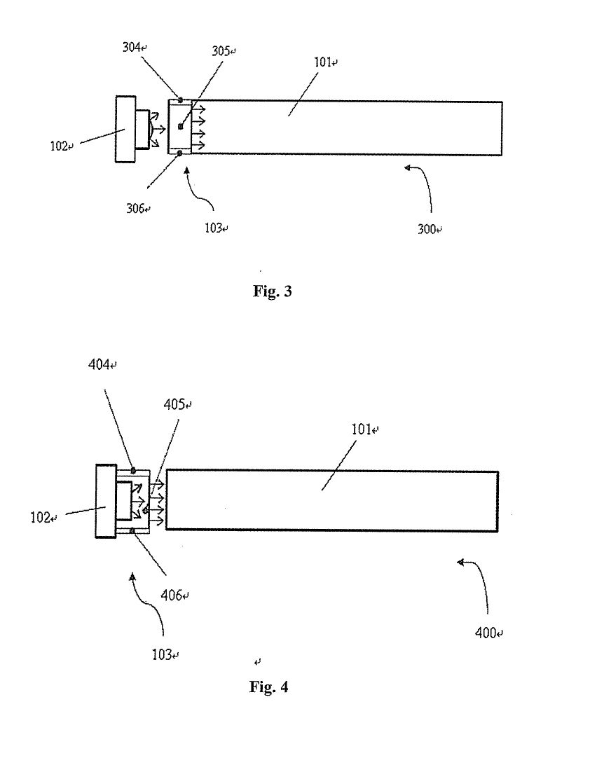

The light mixing unit 103 enables light from the light-emitting element 102 to be subjected to one or more of scattering, refraction and diffusion (with reference to FIG. 2). In this way, the propagation path of the light emitted by the light-emitting element 102 can be greatly affected, and thus the light mixing distance of the light-emitting element 102, i.e. the distance it takes for non-uniform light sources of the light-emitting element 102 to be mixed into a homogenized surface light source, can be reduced. Therefore, the display device is allowed to realize display with a narrow frame area.

The light mixing unit 103 includes a sealed transparent container and a light mixing substance filled in the container. The light mixing substance may include one or more of liquid crystals, atomized acetone and atomized water vapor. However, it may also be other gas-liquid mixture, liquid-solid mixture and the like which exhibits good transmission property. A light mixing layer can be formed after the light mixing substance is filled into the sealed transparent container.

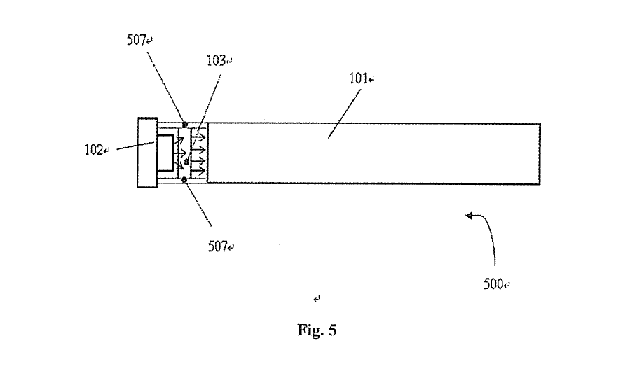

FIG. 3, FIG. 4 and FIG. 5 show different examples of the display device 100 according to the present disclosure respectively.

FIG. 3 shows a display device 300 according to a first example of the present disclosure. In the drawing, the container 304 of the light mixing unit 103 and the light guide plate 101 are integrated into one single body, so that the light mixing substance 305 can be directly located on the side of the light guide plate 101 facing the light-emitting element 102.

However, the container 304 in FIG. 3 may not be integrated with the light guide plate 101, but is instead bonded with the light guide plate 101 with optical adhesive. In this way, it can be ensured that the light mixing substance 305 is directly located on the side of the light guide plate 101 facing the light-emitting element 102.

To improve the utilization efficiency of a light source, a reflecting film 306 may be attached or plated to the outer side of the light mixing layer formed by the light mixing substance 305. The reflecting film 306 may be arranged, for example, on the outer surface of the container 304 at the end in a first direction. The first direction, vertical to the direction of the container 304 facing the light-emitting element 102 and the light guide plate 101, is shown as a vertical direction in the accompanying drawings.

FIG. 4 shows a display device 400 according to a second example of the present disclosure. In the device 400, the container 404 of the light mixing unit 103 and the light-emitting element 102 are integrated into one single body, so that the light mixing substance 405 can surround the side of the light-emitting element 102 facing the light guide plate 101, in particular surround the light guide bar of the light-emitting element 102. To improve the utilization efficiency of a light source, a reflecting film 406 may be attached or plated to the outer side of the light mixing layer formed by the light mixing substance 405. With regard to other specific settings of the reflecting film 406, reference may be made to the first example.

FIG. 5 shows a display device 500 according to a third example of the present disclosure. In the device 500, a support is further provided between the light-emitting element 102 and the light guide plate 101. The support is provided with at least two side walls 507 extending from the light-emitting element 102 to the light guide plate 101, with the light mixing unit 103 arranged between the side walls 507 of the support.

To prevent light leakage, a reflecting sheet may be arranged on the inner surface of the side wall 507 of the support, in order to restrict the light within the support.

Similarly, a reflecting film may also be arranged outside the light mixing layer in the third example. With regard to other specific settings of the reflecting film, reference may be made to the first example.

It could be easily understood by one skilled in the art that the above-mentioned light-emitting element 102 may be a light-emitting diode.

According to the device 100 of the present disclosure, with the light mixing unit 103 as provided, refraction, scattering, diffusion and the like can be greatly increased on the light from the light-emitting element 102, and thus the light mixing distance of the light-emitting element 102 can be significantly shortened. As a result, the light from point light sources can be converted into homogenized light in a relatively short distance. Thus, during the process of manufacturing the display device, the width of the frame can be reduced, and a display with a narrow frame area, which cannot be realized in the prior art, can be achieved.

The present disclosure also proposes a method for manufacturing the display device 100, including the following steps:

(a) providing a container, and filling a light mixing substance into the container, wherein the container is preferably transparent;

(b) sealing the container; and

(c) disposing the sealed container between a light guide plate and a light-emitting element of the display device.

With regard to the specific positions and setting method of the container and the setting of additional components, such as a reflecting film, reflecting sheets and the like, reference can be made to what has been mentioned in the first, second and third examples.

Although the present disclosure has been described with reference to the preferred examples, various modifications could be made to the present disclosure without departing from the scope of the present disclosure and components in the present disclosure could be substituted by equivalents. The present disclosure is not limited to the specific examples disclosed in the description, but includes all technical solutions falling into the scope of the claims.

1. A display device, including
a light guide plate;
a light-emitting element located on one side of the light guide plate; and
a light mixing unit located between the light guide plate and the light-emitting element, and including a sealed transparent container and a light mixing substance filled in the container,
wherein the light mixing unit is configured to enable light from the light-emitting element to be subjected to one or more of scattering, refraction and diffusion.

2. The display device according to claim 1, wherein the container and the light guide plate are integrated into one single body.

3. The display device according to claim 1, wherein the container is bonded with the light guide plate with optical adhesive.

4. The display device according to claim 1, wherein the container and the light-emitting element are integrated into one single body, so that the light mixing substance surrounds the side of the light-emitting element facing the light guide plate.

5. The display device according to claim 1, wherein the device further includes a support between the light-emitting element and the light guide plate, which support is provided with at least two side walls extending from the light-emitting element to the light guide plate, with the light mixing unit arranged between the side walls of the support.

6. The display device according to claim 5, wherein a reflecting sheet is arranged on the inner surface of the side wall of the support.

7. The display device according to claim 1, wherein the light mixing unit further includes a reflecting film arranged on the outer surface of the container at the end in a first direction, which is vertical to the direction of the container facing the light-emitting element and the light guide plate.

8. The display device according to claim 2, wherein the light mixing unit further includes a reflecting film arranged on the outer surface of the container at the end in a first direction, which is vertical to the direction of the container facing the light-emitting element and the light guide plate.

9. The display device according to claim 3, wherein the light mixing unit further includes a reflecting film arranged on the outer surface of the container at the end in a first direction, which is vertical to the direction of the container facing the light-emitting element and the light guide plate.

10. The display device according to claim 4, wherein the light mixing unit further includes a reflecting film arranged on the outer surface of the container at the end in a first direction, which is vertical to the direction of the container facing the light-emitting element and the light guide plate.

11. The display device according to claim 5, wherein the light mixing unit further includes a reflecting film arranged on the outer surface of the container at the end in a first direction, which is vertical to the direction of the container facing the light-emitting element and the light guide plate.

12. The display device according to claim 6, wherein the light mixing unit further includes a reflecting film arranged on the outer surface of the container at the end in a first direction, which is vertical to the direction of the container facing the light-emitting element and the light guide plate.

13. The display device according to claim 1, wherein the light mixing substance includes one or more of liquid crystals, atomized acetone and atomized water vapor.

14. The display device according to claim 2, wherein the light mixing substance includes one or more of liquid crystals, atomized acetone and atomized water vapor.

15. The display device according to claim 3, wherein the light mixing substance includes one or more of liquid crystals, atomized acetone and atomized water vapor.

16. The display device according to claim 4, wherein the light mixing substance includes one or more of liquid crystals, atomized acetone and atomized water vapor.

17. The display device according to claim 5, wherein the light mixing substance includes one or more of liquid crystals, atomized acetone and atomized water vapor.

18. The display device according to claim 6, wherein the light mixing substance includes one or more of liquid crystals, atomized acetone and atomized water vapor.

19. The display device according to claim 7, wherein the reflecting film is arranged on the container through attaching or plating.

20. A method for manufacturing a display device, the device including:
a light guide plate;
a light-emitting element located on one side of the light guide plate; and
a light mixing unit located between the light guide plate and the light-emitting element and including a sealed transparent container and a light mixing substance filled in the container,
wherein the light mixing unit enables light from the light-emitting element to be subjected to one or more of scattering, refraction and diffusion,
the method including the following steps:
(a) providing a container, and filling a light mixing substance into the container;
(b) sealing the container; and
(c) disposing the sealed container between a light guide plate and a light-emitting element of the display device.
